(19) United States
(12) Patent Application Publication
(10) Pub. No.: US 2015/0196885 A1
(43) Pub. Date: Jul. 16, 2015

(54) METHODS AND SYSTEMS FOR CODING SYNTHESIS GAS

(71) Applicants: IWAN H. CHAN, Houston, TX (US); Yongchao Li, Katy, TX (US); John Abughazaleh, Sugar Land, TX (US); Anant Pisut, Houston, TX (US)

(72) Inventors: IWAN H. CHAN, Houston, TX (US); Yongchao Li, Katy, TX (US); John Abughazaleh, Sugar Land, TX (US); Anant Pisut, Houston, TX (US)

(73) Assignee: KELLOGG BROWN & ROOT LLC, Houston, TX (US)

(21) Appl. No.: 14/155,413

(22) Filed: Jan. 15, 2014

(51) Int. Cl. B01J 19/00; B01J 19/14; C01B 3/00

(52) U.S. Cl. CPC B01J 19/0013; C01B 3/00; B01J 19/14; B01J 2219/00092; B01J 2219/00103

(57) ABSTRACT

A heat exchanger including a housing. A plurality of tubes can be disposed within the housing. A plurality of solid particulates can be disposed within the housing between an inner surface of the housing and outer surfaces of the tubes, wherein the solid particulates have an average cross-sectional length from about 250 μm to about 5 mm.

### BACKGROUND

1. Field

Embodiments described herein generally relate to the gasification of hydrocarbons. More particularly, such embodiments relate to cooling synthesis gas (or “syngas”) produced from a gasification process.

2. Description of the Related Art

In a hydrocarbon gasification process, a gasifier outputs a synthesis gas at a temperature from about 800° C. to about 1,200° C. This hot synthesis gas is introduced to a shell and tube heat exchanger to reduce the temperature down to about 200° C. to about 400° C. The synthesis gas typically includes fine ash, tar, and soot particulates. The tar and soot particulates oftentimes cause plugging and/or fouling of the heat exchanger. In addition, the synthesis gas flows through the heat exchanger at about 15 m/s to about 25 m/s. At this velocity, the tar and soot particulates tend to cause erosion of the tubes in the heat exchanger.

There is a need, therefore, for new systems and methods for cooling synthesis gas produced from a gasification process.

### SUMMARY

A heat exchanger is disclosed. The heat exchanger can include a housing. A plurality of tubes can be disposed within the housing. A plurality of solid particulates can be disposed within the housing between an inner surface of the housing and outer surfaces of the tubes. The solid particulates can have an average cross-sectional length from about 250 μm to about 5 mm.

A system for cooling a synthesis gas is also disclosed. The system can include a gasifier, a heat exchanger, and a reservoir. The gasifier can convert a feed to a synthesis gas. The heat exchanger can include a housing and be adapted to receive the synthesis gas from the gasifier. A plurality of tubes disposed within the housing can have a heat transfer fluid flow therethrough. A first plurality of solid particulates can be disposed within the housing between an inner surface of the housing and outer surfaces of the tubes. The reservoir can have a second plurality of solid particulates disposed therein. The reservoir can include an inlet for receiving at least a portion of the first plurality of solid particulates from the heat exchanger. The reservoir can also include an outlet for transferring at least a portion of the second plurality of solid particulates to the heat exchanger.

A method for cooling a synthesis gas is also disclosed. The method can include introducing a synthesis gas at a first temperature to a first inlet of a heat exchanger. The synthesis gas can flow through a plurality of solid particulates disposed within an interior volume of the heat exchanger, and the solid particulates can absorb heat from the synthesis gas. A heat transfer fluid can be introduced to a second inlet of the heat exchanger at a second temperature. The heat transfer fluid can flow through a plurality of tubes in the heat exchanger, and the heat transfer fluid can absorb heat from the solid particulates through the tubes. The synthesis gas can be discharged through a first outlet of the heat exchanger at a second temperature. The heat transfer fluid can be discharged through a second outlet of the heat exchanger at a second temperature.

### BRIEF DESCRIPTION OF THE DRAWINGS

FIG. 1 depicts a cross-sectional side view of an illustrative heat exchanger, according to one or more embodiments described.

FIG. 2 depicts a schematic view of an illustrative heat exchange system for varying the amount of solid particulates in the heat exchanger, according to one or more embodiments described.

FIG. 3 depicts a schematic view of an illustrative gasification system incorporating the heat exchange system shown in FIG. 2, according to one or more embodiments described.

### DETAILED DESCRIPTION

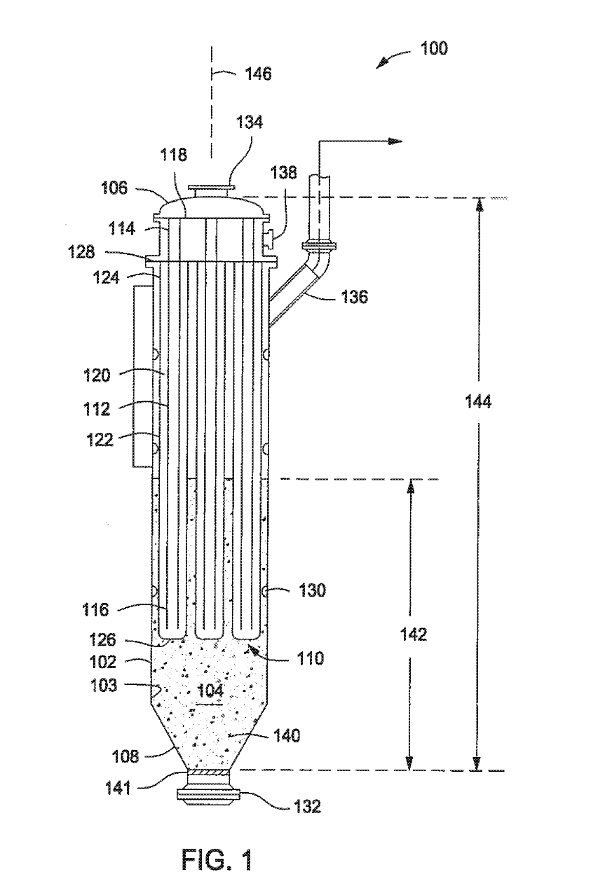

FIG. 1 depicts a cross-sectional side view of an illustrative heat exchanger 100, according to one or more embodiments. The heat exchanger 100 can include an elongated vessel or housing 102 defining an internal volume 104. The housing 102 can made from suitable metals, metal alloys, composite materials, polymeric materials, combinations thereof, or the like. For example, the housing 102 can be made of carbon steel or low chrome steel. The housing 102 can have any desired shape including, but not limited to, a cube, a rectangular box, a cylinder, a triangular prism, a hyperboloid structure, or some other shape or combination thereof. As shown, the housing 102 is substantially cylindrical having a first or “upper” end 106 and a second or “lower” end 108. The cross-sectional length (e.g., diameter) of the housing 102 can taper down proximate the second end 108 thereof. As shown, the housing 102 can be frustoconical proximate the second end 108 thereof.

One or more tubes, also known as a tube bundle, 110 can be disposed within the interior volume 104 of the housing 102. The number of tubes can range from about 1, about 2, about 5, about 10, or about 15 to about 20, about 50, about 100, about 200, about 500, or more. Each tube in the bundle 110 can include an inner tube 112 disposed within an outer tube 122. Each pair of inner and outer tubes 112, 122 forms an annulus 120 therebetween. The inner and outer tubes 112, 122 can form or provide what is commonly referred to as bayonet type or bayonet style tubes.

First or “upper” ends 114 of the inner tubes 112 and second or “lower” ends 116 of the inner tubes 112 can be open enabling fluid to flow therethrough. The inner tubes 112 can be coupled to and supported by one or more support members, such as a first or “upper” tube sheet 118. As shown, the first tube sheet 118 can be coupled to the inner tubes 112 proximate the first ends 114 thereof.

First or “upper” ends 124 of the outer tubes 122 can be open enabling fluid to flow therethrough, and second or “lower” ends 126 of the outer tubes 122 can be closed preventing fluid from flowing therethrough. The outer tubes 122 can be supported by one or more support members, such as a second or “lower” tube sheet 128. The second tube sheet 128 can be coupled to the outer tubes 122 proximate the first ends 124 thereof. The second tube sheet 128 can be coupled to the inner surface 103 of the housing 102 and adapted to prevent fluid flow axially therethrough (except through the tube bundle 110).

As shown, the first tube sheet 118 is positioned above the second tube sheet 128, and the first ends 114 of the inner tubes 112 are positioned above the first ends 124 of the outer tubes 122. However, in another embodiment, the first tube sheet 118 can be positioned below the second tube sheet 128, and the first ends 114 of the inner tubes 112 can be positioned below the first ends 124 of the outer tubes 122.

One or more stabilizers 130 can be disposed within the interior volume 104 of the housing 102 to reduce or prevent vibration of the inner and/or outer tubes 112, 122. The stabilizers 130 can be coupled to the inner surface 103 of the housing 102 and adapted to contact the outer surface of the outer tubes 122. In another embodiment, the stabilizers 130 can be coupled to the outer surface of the outer tubes 122.

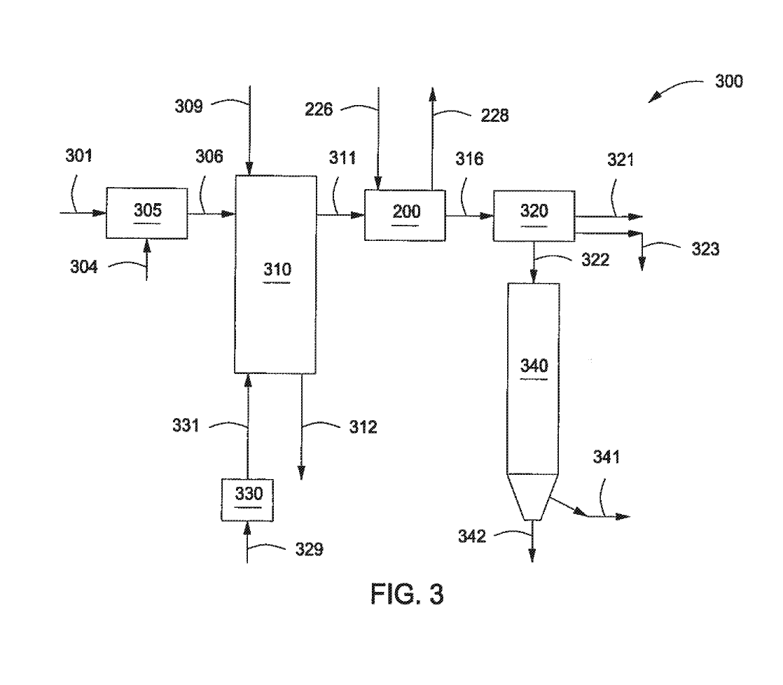

The housing 102 can include a first inlet 132, a second inlet 134, a first outlet 136, and a second outlet 138. Synthesis gas from a gasifier can be introduced into the interior volume 104 of the housing 102 through the first inlet 132. The first inlet 132 can be disposed proximate the second end 108 of the housing 102. As shown, the first inlet 132 can be disposed below the second ends 116, 126 of the tubes 112, 122. The properties of the synthesis gas are described in more detail with respect to FIG. 3.

The synthesis gas can exit the housing 102 via the first outlet 136. The first outlet 136 can be disposed proximate the first end 106 of the housing 102. As shown, the first outlet 136 can be disposed below the second tube sheet 128 (i.e., between the second tube sheet 128 and the second end 108 of the housing 102).

The second inlet 134 can introduce a heat transfer medium or fluid into the interior volume 104 of the housing 102. The second inlet 134 can be disposed proximate the first end of the housing 102. As shown, the second inlet 134 can be disposed above the first tube sheet 118 and the first end 106 of the housing 102. As such, the heat transfer fluid can flow into the interior volume 104 of the housing 102 via the second inlet 134 and then flow into the inner tubes 112. The heat transfer fluid can be a coolant including, but not limited to, water (e.g., process water or boiler feed water), superheated low-pressure steam, superheated medium pressure steam, superheated high-pressure steam, saturated low-pressure steam, saturated medium pressure steam, saturated high-pressure steam, combinations thereof, and the like.

The heat transfer fluid can exit the housing 102 via the second outlet 138. The second outlet 138 can be disposed proximate the first end 106 of the housing 102. As shown, the second outlet 138 is disposed between the first and second tube sheets 118, 128.

A plurality of solid particulates 140 can be disposed in the interior volume 104 of the housing 102, thereby forming a bed. The solid particulates 140 can be disposed between the inner surface 103 of the housing 102 and the outer surface of the outer tubes 122. In addition, the solid particulates 140 can be disposed between the second tube sheet 128 and the second end 108 of the housing 102. The solid particulates 140 can be or include inert solids such as sand (e.g., high-alumina sand), gravel, ash, ceramic particles, combinations thereof, and the like.

The solid particulates 140 can have an average cross-sectional length ranging from about 100 μm, about 200 μm, about 300 μm, about 400 μm, or about 500 μm to about 600 μm, about 800 μm, about 1 mm, about 1.5 mm, about 2 mm, about 5 mm, about 10 mm, or more. For example, the average cross-sectional length can be from about 100 μm to about 250 μm, about 250 μm to about 500 μm, about 500 μm to about 750 μm, about 750 μm to about 1 mm, about 1 mm to about 5 mm, or about 250 μm to about 5 mm.

A filter or grate 141 can be disposed within the housing 102. The grate 141 can be positioned proximate the lower end 108 of the housing 102. The grate 141 can have a plurality of openings formed therethrough. The openings can be sized such that the synthesis gas from the gasifier 150 can flow (upward) therethrough, but the solid particulates 140 cannot flow (downward) therethrough. For example, the cross-sectional length of the openings can be less than about 1 mm, less than about 750 μm, less than about 500 μm, less than about 250 μm, or less than about 100 μm.

The solid particulates 140 can fill about 10%, about 20%, about 30%, about 40%, about 50%, about 60%, about 70%, about 80%, or about 90% of the internal volume 104 of the housing 102. For example, the solid particulates 140 can fill between about 10% and about 30%, about 20% and about 40%, about 30% and about 50%, about 40% and about 60%, about 50% and about 70%, about 60% and about 80%, or about 10% to about 80% of the internal volume 104 of the housing 102. As a result, a height 142 of the bed of solid particulates 140 can be about 10%, about 20%, about 30%, about 40%, about 50%, about 60%, about 70%, about 80%, or about 90% of a length 144 of the housing 102, as measured along a central longitudinal axis 146 of the housing 102. For example, a ratio of the height 144 of the bed of solid particulates 140 to the length 146 of the housing 102 can be from about 0.1:1 to about 0.3:1, about 0.2:1 to about 0.4:1, about 0.3:1 to about 0.5:1, about 0.4:1 to about 0.6:1, about 0.5:1 to about 0.7:1, about 0.6:1 to about 0.8:1, about 0.7:1 to about 0.9:1, about 0.8:1 to about 1:1, or about 0.1:1 to about 0.8:1.

In operation, the synthesis gas can be discharged from the gasifier and introduced to the heat exchanger 100 via the first inlet 132. The synthesis gas introduced to the heat exchanger 100 can have a temperature ranging from about 800° C., about 850° C., about 900° C., about 950° C., or about 1,000° C. to about 1,050° C., about 1,100° C., about 1,200° C., about 1,300° C., about 1,400° C., or more. For example, the temperature can be from about 800° C. to about 900° C., about 850° C. to about 950° C., about 900° C. to about 1,000° C., about 950° C. to about 1,050° C., about 1,000° C. to about 1,100° C., about 1,100° C. to about 1,200° C., about 1,200° C. to about 1,300° C., about 1,300° C. to about 1,400° C., or about 800° C. to about 1,200° C.

Upon exiting the gasifier (or entering the heat exchanger 100), the synthesis gas can have a pressure ranging from about 500 kPa, about 1,000 kPa, about 1,500 kPa, about 2,000 kPa, about 2,500 kPa, or about 3,000 kPa to about 4,000 kPa, about 5,000 kPa, about 6,000 kPa, about 7,000 kPa, or more. For example, the pressure can be from about 500 kPa to about 1,000 kPa, about 1,000 kPa to about 2,000 kPa, about 2,000 kPa to about 3,000 kPa, about 3,000 kPa to about 4.000 kPa, about 4,000 kPa to about 5,000 kPa, or about 5,000 kPa to about 6.000 kPa.

The synthesis gas can enter the housing 102 via the first inlet 132. The synthesis gas can then flow up through the housing 102 toward the first outlet 136. As the synthesis gas flows up through the housing 102, the synthesis gas flows through the solid particulates 140 causing the solid particulates 140 to move, thereby forming a fluidized bed of solid particulates 140. The fluidized bed of solid particulates 140 can have any desired density. For example, fluidized bed of solid particulates 140 can have a density from about 250 kg/m³ to about 2,000 kg/m³. Any tar, soot, and/or ash particles from the synthesis gas that collect on the inner surface 103 of the housing 102 and/or the outer surface of the outer tubes 122 can be cleaned off due to abrasive contact with the moving solid particulates 140. Such particles in the synthesis gas can have an average cross-sectional length ranging from about 10 μm, about 20 μm, or about 30 μm to about 50 μm, about 75 μm, or about 100 μm.

The solid particulates 140 can absorb heat from the synthesis gas, thereby cooling the synthesis gas. As the synthesis gas flows into the portion of the internal volume 104 above the solid particulates 140 and below the second tube sheet 128, the synthesis gas can continue to cool by transferring heat to the heat transfer fluid flowing through the outer tubes 122. However, as may be appreciated, the amount of heat transferred from the synthesis gas per linear (e.g., vertical) meter travelled in the internal volume 104 is greater in the portion of the volume including the solid particulates 140 than in the portion above the solid particulates 140. In other words, the solid particulates 140 can absorb heat from the synthesis gas faster than the tubes 112, 122 and the heat transfer fluid can by themselves. Accordingly, the amount that the temperature of the synthesis gas decreases in the heat exchanger 100 can depend, at least in part, on the amount/height 142 of the solid particulates 140 in the interior volume 104.

The synthesis can enter, exit, and/or flow through the heat exchanger 100 at a flow rate ranging from about 1 cm/s, about 5 cm/s, about 10 cm/s, about 15 cm/s, or about 20 cm/s to about 30 cm/s, about 40 cm/s, about 50 cm/s, about 100 cm/s, about 200 cm/s, or more. For example, the flow rate of the synthesis gas can be from about 1 cm/s to about 10 cm/s, about 10 cm/s to about 20 cm/s, about 20 cm/s to about 30 cm/s, about 30 cm/s to about 50 cm/s, about 50 cm/s to about 100 cm/s, about 100 cm/s to about 200 cm/s, or about 1 cm/s to about 50 cm/s. As such, the volumetric flow rate into, out from, and/or through the heat exchanger 100 can range from about 0.1 m³/s, about 0.2 m³/s, about 0.5 m³/s, about 1 m³/s, or about 2 m³/s to about 5 m³/s, about 10 m³/s, about 20 m³/s, about 50 m³/s, or about 100 m³/s. For example, the volumetric flow rate can be from about 0.1 m³/s to about 0.5 m³/s, about 0.5 m³/s to about 1 m³/s, about 1 m³/s to about 5 m³/s, or about 5 m³/s to about 50 m³/s. At this relatively “slow” flow rate, any erosion of the tubes 112, 122 can be less than that which occurs within conventional heat exchangers having higher flow rates.

The synthesis gas can have a residence time in the heat exchanger 100 ranging from a low of about 1 second, about 5 seconds, about 10 seconds, about 30 seconds, or about 1 minute to a high of about 2 minutes, about 5 minutes, about 10 minutes, about 30 minutes, about 1 hour, or more. For example, the synthesis gas can have a residence time within the heat exchanger 100 ranging from about 5 seconds to about 30 seconds, about 30 seconds to about 1 minute, about 1 minute to about 3 minutes, about 3 minutes to about 10 minutes, about 10 minutes to about 30 minutes, or about 30 minutes to about 1 hour.

The cooled synthesis gas can be discharged from the housing 102 via the first outlet 136. Upon exiting the first outlet 136, the synthesis gas can have a temperature ranging from about 200° C., about 225° C., about 250° C., about 275° C., or about 300° C. to about 325° C., about 350° C., about 375° C., about 400° C., about 425° C., about 450° C., about 500° C., or more. For example, the temperature can be from about 200° C. to about 250° C., about 250° C. to about 300° C., about 300° C. to about 350° C., about 350° C. to about 400° C., about 400° C. to about 450° C., or about 200° C. to about 500° C. Upon exiting the housing 102, the synthesis gas can have a pressure ranging from about 450 kPa to about 6,950 kPa.

As the solid particulates 140 absorb heat from the synthesis gas, the temperature of the solid particulates 140 can increase. To maintain the temperature of the solid particulates below a predetermined temperature, the solid particulates 140 can transfer heat to the heat transfer fluid. The predetermined temperature of the solid particulates 140 can be less than about 350° C., less than about 300° C., less than about 250° C., less than about 200° C., less than about 150° C., or less than about 100° C.

The heat transfer fluid can be introduced to the housing 102 via the second inlet 134. Upon entering the housing 102, the heat transfer fluid can have a temperature ranging from about 10° C., about 25° C., about 50° C., about 75° C., or about 100° C. to about 125° C., about 150° C., about 175° C., about 200° C., about 250° C., about 300° C., or more. For example, the temperature of the heat transfer fluid can be from about 10° C. to about 50° C., about 50° C. to about 100° C., about 100° C. to about 150° C., about 150° C. to about 200° C., or about 200° C. to about 300° C.

The heat transfer fluid can flow downward through the inner tubes 112. Once the heat transfer fluid reaches the second ends 116, 126 of the tubes 112, 122, the heat transfer fluid can flow upward through the annulus 120 between the inner and outer tubes 112, 122, absorbing heat from the solid particulates 140 through the outer tubes 122. Although not shown, in another embodiment, the heat transfer fluid can flow downward through the annulus 120 and flow back up through the inner tubes 112. The heat transfer fluid can be discharged from the housing 102 via the second outlet 138. Upon exiting the housing 102, the heat transfer fluid can have a temperature ranging from about 100° C., about 125° C., about 150° C., about 175° C., or about 200° C. to about 250° C., about 300° C., about 350° C., about 400° C., about 450° C., about 500° C., or more. For example, the temperature can be from about 100° C. to about 150° C., about 150° C. to about 200° C., about 200° C. to about 250° C., about 250° C. to about 300° C., or about 300° C. to about 350° C.

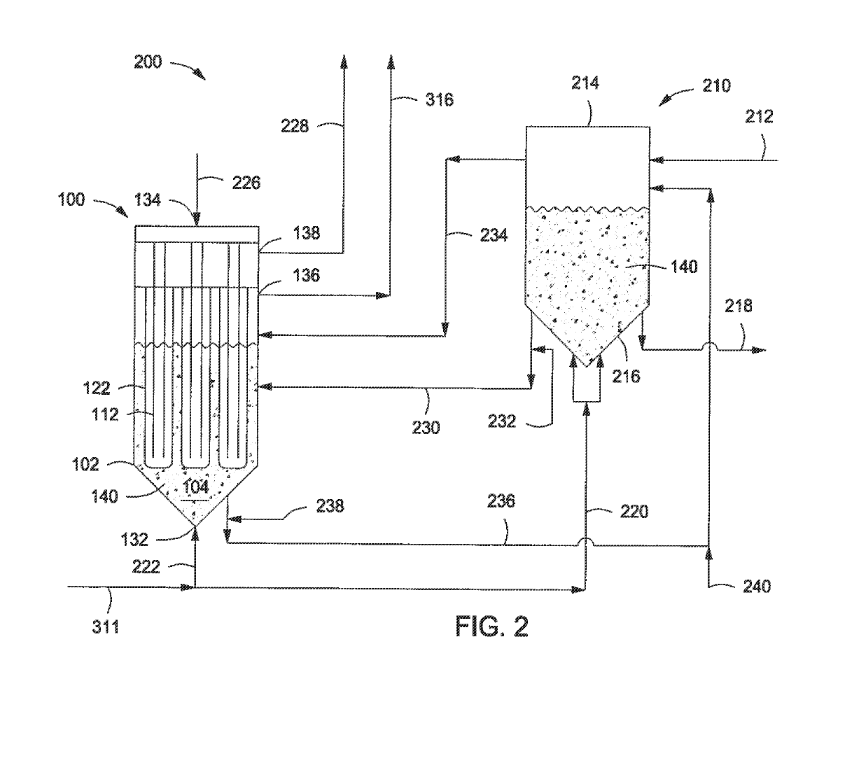

FIG. 2 depicts a schematic view of an illustrative heat exchange system 200 for varying the amount of solid particulates 140 in the heat exchanger 100, according to one or more embodiments. The system 200 can include the heat exchanger 100 and a reservoir 210. The reservoir 210 can be adapted to store solid particulates 140 that are not being used in the heat exchanger 100. The solid particulates 140 can be introduced to the reservoir 210 via line 212. As shown, the line 212 can be coupled to the reservoir 210 proximate a first or “upper” end 214 of the reservoir 210 so that the solid particulates 140 introduced to the reservoir 210 can drop down to the bed of solid particulates 140 via gravity. The solid particulates 140 can be removed from the reservoir 210 via line 218. As shown, the line 218 can be coupled to the reservoir 210 proximate a second or “lower” end 216 of the reservoir 210 so that the solid particulates 140 can flow into the line 218 via gravity.

The synthesis gas can exit the gasifier via line 311. At least a portion of the synthesis gas in line 311 can be introduced to the reservoir via line 220. The line 220 can be coupled to the reservoir 210 proximate the second end 216 thereof. The synthesis gas from line 220 can flow up through the solid particulates 140 in the reservoir 210 to fluidize the solid particulates 140 in the reservoir 210. The synthesis gas can also keep the solid particulates 140 in the reservoir 210 relatively hot (e.g., between about 200° C. and about 600° C.). In at least one embodiment, the line 220 can be split or divided into two or more lines to increase the fluidization of the solid particulates 140.

In operation, the synthesis gas can be output from the gasifier and flow through lines 311, 222 and the first inlet 132 into to the interior volume 104 of the housing 102. The synthesis gas can flow up through the solid particulates 140, thereby fluidizing the solid particulates 140 and transferring heat to the solid particulates 140. The cooled synthesis gas can exit the heat exchanger 100 via the first outlet 136 into line 316, which can take the synthesis gas for further processing.

The heat transfer fluid can flow through the line 226 and the second inlet 134 into the interior volume 104 of the housing 102. The heat transfer fluid can flow through the tubes 112, 122, absorbing heat from the solid particulates 140. The heated heat transfer fluid can exit the heat exchanger 100 via the second outlet 138 into line 228.

To increase the amount of heat transferred from the synthesis gas within the heat exchanger 100 (causing the synthesis gas to exit the heat exchanger 100 at a lower temperature), the amount of solid particulates 140 and/or the height 142 of the bed of solid particulates 140 in the interior volume 104 of the heat exchanger 100 can be increased. The amount of solid particulates 140 and/or the height 142 (see FIG. 1) of the bed of solid particulates 140 in the interior volume 104 of the heat exchanger 100 can be increased by transferring additional solid particulates 140 from the reservoir 210 to the interior volume 104 of the heat exchanger 100. This can be accomplished by introducing an aeration fluid into a line 230 extending between the reservoir 210 and the heat exchanger 100. As shown, the aeration fluid can be introduced into the line 232 at a point 232 above the “L-shaped” bend in the line 230. The aeration fluid can be a gas such as air, steam, syngas, carbon dioxide, and combinations thereof.

The aeration fluid introduced via line 230 can cause a portion of the solid particulates 140 in the reservoir 210 to flow down into the line 230 and toward the heat exchanger 100. The line 230 can be coupled to the heat exchanger 100 proximate the first end 106 thereof, proximate the second end 108 thereof, or anywhere in between (see FIG. 1). The solid particulates 140 in the line 230 can be introduced into the interior volume 104 of the heat exchanger 100, thereby increasing the amount of solid particulates 140 and/or the height 142 of the bed of solid particulates 140 therein. The flow of the solid particulates 140 between the reservoir 210 and the heat exchanger 100 can be facilitated by having the reservoir 210 and the heat exchanger 100 at substantially the same pressure. A pressure equalizing line 234 can provide a path of fluid communication between the reservoir 210 and the heat exchanger 100 to equalize the pressure therebetween. As used herein, “substantially the same pressure” means within about 70 kPa or less.

To decrease the amount of heat transferred from the synthesis gas within the heat exchanger 100 (causing the synthesis gas to exit the heat exchanger 100 at a higher temperature), the amount of solid particulates 140 and/or the height 142 of the bed of solid particulates 140 in the interior volume 104 of the heat exchanger 100 can be decreased. The amount of solid particulates 140 and/or the height 142 of the bed of solid particulates 140 in the interior volume 104 of the heat exchanger 100 can be decreased by transferring solid particulates 140 from the interior volume 104 of the heat exchanger 100 to the reservoir 210. This can be accomplished by introducing an aeration fluid into a line 236 extending between the reservoir 210 and the heat exchanger 100. The aeration fluid can be introduced into the line 236 at a point 238 in the vertical portion of the line 236. The aeration fluid introduced to the line 236 at point 238 can cause a portion of the solid particulates 140 to flow out of the interior volume 104 of the heat exchanger 100 and into the line 236.

Additional aeration fluid can be introduced into the line 236 at point 240. The point 240 can be proximate the lower end of the vertical portion of the line 236. The aeration fluid introduced at point 240 can lift the solid particulates 140 up through the vertical portion of the line 236 and into the reservoir 210. The aeration fluid introduced at point 240 can be the same as the aeration fluid introduced at point 238, or it can be different.

FIG. 3 depicts a schematic of an illustrative gasification system 300 incorporating the heat exchange system 200 shown in FIG. 2, according to one or more embodiments. The gasification system 300 can include one or more hydrocarbon preparation units 305, gasifiers 310, particulate control devices 320, and heat exchange systems 200, 340. A feedstock via line 301 can be introduced to the hydrocarbon preparation unit 305 to produce a gasifier feed via line 306. The feedstock via line 301 can include one or more carbonaceous materials, whether solid, liquid, gas, or a combination thereof. The carbonaceous materials can include, but are not limited to, biomass (e.g., plant and/or animal matter or plant and/or animal derived matter); coal (e.g., high-sodium and low-sodium lignite, lignite, sub-bituminous, and/or anthracite); oil shale; coke; tar; asphaltenes; low ash or no ash polymers; hydrocarbon-based polymeric materials; biomass derived material; or by-product derived from manufacturing operations. The hydrocarbon-based polymeric materials can include, for example, thermoplastics, elastomers, rubbers, including polypropylenes, polyethylenes, polystyrenes, including other polyolefins, homo polymers, copolymers, block copolymers, and blends thereof; PET (polyethylene terephthalate), poly blends, other polyolefins, poly-hydrocarbons containing oxygen; heavy hydrocarbon sludge and bottoms products from petroleum refineries and petrochemical plants such as hydrocarbon waxes, blends thereof, derivatives thereof, and any combination thereof.

The feedstock via line 301 can include a mixture or combination of two or more carbonaceous materials. For example, the feedstock via line 301 can include a mixture or combination of two or more low ash or no ash polymers, biomass-derived materials, or by-products derived from manufacturing operations. In another example, the feedstock via line 301 can include one or more carbonaceous materials combined with one or more discarded consumer products, such as carpet and/or plastic automotive parts/components including bumpers and dashboards. Such discarded consumer products can be reduced in size to fit within the gasifier 310. Accordingly, the gasification system 300 can be useful for accommodating mandates for proper disposal of previously manufactured materials.

The hydrocarbon preparation unit 305 can be any preparation unit known in the art, depending on the feedstock via line 301 and the desired synthesis gas product in line 321. For example, the hydrocarbon preparation unit 305 can remove contaminants from the feedstock via line 301 by washing away dirt or other undesired portions. The feedstock via line 301 can be a dry feed or can be conveyed to the hydrocarbon preparation unit 305 as a slurry or suspension. The feedstock via line 301 can be dried and then pulverized by one or more milling units (not shown) prior to being introduced to the hydrocarbon preparation unit 305. For example, the feedstock via line 301 can be dried from a high of about 35% moisture to a low of about 18% moisture. A Fluid bed drier (not shown) can be used to dry the feedstock via line 301, for example. The feedstock via line 301 can have an average particle diameter size of from about 10 μm to about 100 μm, or about 100 μm to about 250 μm. The gasifier feed via line 306, one or more oxidants via line 331, and/or steam via line 309 can be introduced to the gasifier 310 to produce a raw synthesis gas via line 311 and waste, e.g., coarse ash, via line 312.

The oxidant via line 331 can be supplied by an air separation unit 330 to the gasifier 310. The air separation unit 330 can provide pure oxygen, nearly pure oxygen, essentially oxygen, or oxygen-enriched air to the gasifier 310 via line 331. The air separation unit 330 can provide a nitrogen-lean, oxygen-rich feed to the gasifier 310 via line 331, thereby minimizing the nitrogen concentration in the raw synthesis gas provided via line 311 to the synthesis gas cooler 200. The use of a pure or nearly pure oxygen feed allows the gasifier 310 to produce a synthesis gas that can be essentially nitrogen-free, e.g., containing less than about 0.5 mol % nitrogen/argon. The air separation unit 330 can be a high-pressure, cryogenic type separator. Air can be introduced to the air separation unit 330 via line 329. Although not shown, separated nitrogen from the air separation unit 330 can be introduced to a combustion turbine. The air separation unit 330 can provide from about 10%, about 30%, about 50%, about 70%, about 90%, or about 100% of the total oxidant introduced to the gasifier 310.

Although not shown, one or more sorbents can be added to the gasifier 310. The one or more sorbents can be added to capture contaminants from the raw synthesis gas, such as sodium vapor in the gas phase within the gasifier 310. The one or more sorbents can be added to scavenge oxygen at a rate and level sufficient to delay or prevent the oxygen from reaching a concentration that can result in undesirable side reactions with hydrogen (e.g., water) from the feedstock within the gasifier 310. The one or more sorbents can be mixed or otherwise added to the one or more hydrocarbons. The one or more sorbents can be used to dust or coat the feedstock particles in the gasifier 310 to reduce the tendency for the particles to agglomerate. The one or more sorbents can be ground to an average particle size of about 5 μm to about 100 μm, or about 10 μm to about 75 μm. Illustrative sorbents can include but are not limited to, carbon-rich ash, limestone, dolomite, and coke breeze. Residual sulfur released from the feedstock can be captured by native calcium in the feed or by a calcium-based sorbent to form calcium sulfide.

The gasifier 310 can be one or more circulating solid or transport gasifiers, one or more counter-current fixed bed gasifiers, one or more co-current fixed bed gasifiers, one or more fluidized bed reactors, one or more entrained flow gasifiers, any other type of gasifier, or any combination thereof. An exemplary circulating solid gasifier is discussed and described in U.S. Pat. No. 7,322,690.

The gasifier 310 can produce a raw synthesis gas via line 311, while waste from the gasifier 310, e.g., ash or coarse ash, can be removed via line 312. The waste or ash removed via line 312 can be larger in size than the fine ash via line 322. The waste or ash via line 312 can be disposed of or can be used in other applications. Although not shown, the ash in line 312 can be introduced to the heat exchange system 200 with the fine ash in line 312. Steam via line 309 can be introduced to the gasifier 310 to support the gasification process. In one or more embodiments, however, the gasifier 310 may not require direct steam introduction via line 309.

The raw synthesis gas via line 311 produced in the gasifier 310 can include carbon monoxide, hydrogen, oxygen, methane, carbon dioxide, hydrocarbons, sulfur, solids, mixtures thereof, derivatives thereof, or combinations thereof. The raw synthesis gas via line 311 can contain 85% or more carbon monoxide and hydrogen with the balance being primarily carbon dioxide and methane. The gasifier 310 can convert at least about 85%, about 90%, about 95%, about 98%, or about 99% of the carbon from the gasifier feed via line 306 to synthesis gas.

The raw synthesis gas via line 311 can contain 90% or more carbon monoxide and hydrogen, 95% or more carbon monoxide and hydrogen, 97% or more carbon monoxide and hydrogen, or 99% or more carbon monoxide and hydrogen. The carbon monoxide content of the raw synthesis gas via line 311 produced in the gasifier 310 can range from a low of about 10 vol %, about 20 vol %, or about 30 vol % to a high of about 60 vol %, about 70 vol %, about 80 vol %, or about 90 vol %. For example, carbon monoxide content of the raw synthesis gas via line 311 can range from about 15 vol % to about 85 vol %, about 25 vol % to about 75 vol %, or about 35 vol % to about 65 vol %.

The hydrogen content of the raw synthesis gas via line 311 can range from a low of about 1 vol %, about 5 vol %, or about 10 vol % to a high of about 30 vol %, about 40 vol %, or about 50 vol %. For example, the hydrogen content of the raw synthesis gas via line 311 can range from about 5 vol % to about 45 vol % hydrogen, from about 10 vol % to about 35 vol % hydrogen, or from about 10 vol % to about 25 vol % hydrogen.

The raw synthesis gas via line 311 can contain less than 25 vol %, less than 20 vol %, less than 15 vol %, less than 10 vol %, or less than 5 vol %, of combined nitrogen, methane, carbon dioxide, water, hydrogen sulfide, and hydrogen chloride. The nitrogen content of the raw synthesis gas via line 311 can range from a low of about 0 vol %, about 0.5 vol %, about 1.0 vol %, or about 1.5 vol % to a high of about 2.0 vol %, about 2.5 vol %, or about 3.0 vol %. The raw synthesis gas via line 311 can be nitrogen-free or essentially nitrogen-free, e.g., containing 0.5 vol % nitrogen or less.

The methane content of the raw synthesis gas via line 311 can range from a low of about 0 vol %, about 2 vol %, or about 5 vol % to a high of about 10 vol %, about 15 vol %, or about 20 vol %. For example, the methane content of the raw synthesis gas via line 311 can range from about 1 vol % to about 20 vol %, from about 5 vol % to about 15 vol %, or from about 5 vol % to about 10 vol %. In another example, the methane content of the raw synthesis gas via line 311 can be about 15 vol % or less, 10 vol % or less, 5 vol % or less, 3 vol % or less, 2 vol % or less, or 1 vol % or less.

The carbon dioxide content of raw synthesis gas via line 311 can range from a low of about 0 vol %, about 5 vol %, or about 10 vol % to a high of about 20 vol %, about 25 vol %, or about 30 vol %. For example, the carbon dioxide content of raw synthesis gas via line 311 can be about 20 vol % or less, about 15 vol % or less, about 10 vol % or less, about 5 vol % or less, or about 1 vol % or less.

The water content of the raw synthesis gas via line 311 can be about 40 vol % or less, 30 vol % or less, 25 vol % or less, 20 vol % or less, 15 vol % or less, 10 vol % or less, 5 vol % or less, 3 vol % or less, 2 vol % or less, or 1 vol % or less.

The raw synthesis gas via line 311 leaving the gasifier 310 can have a heating value, corrected for heat losses and dilution effects, of about 1,863 kJ/m³ (50 Btu/scf) to about 2,794 kJ/m³ (75 Btu/scf); about 1,863 kJ/m³ to about 3,726 kJ/m³ (100 Btu/scf); about 1,863 kJ/m³ to about 4,098 kJ/m³ (110 Btu/scf); about 1,863 kJ/m³ to about 5,516 kJ/m³ (140 Btu/scf); about 1,863 kJ/m³ to about 6,707 kJ/m³ (180 Btu/scf); about 1,863 kJ/m³ to about 7,452 kJ/m′ (200 Btu/scf); about 1,863 kJ/m³ to about 9,315 kJ/m³ (250 Btu/scf); about 1,863 kJ/m³ to about 10,246 kJ/m³ (275 Btu/scf), 1,863 kJ/m³ to about 11,178 kJ/m³ (300 Btu/set), or about 1,863 kJ/m³ to about 14,904 kJ/m³ (200 Btu/scf).

As discussed above, the raw synthesis gas via line 311 can exit the gasifier 310 at a temperature ranging from about 800° C. to about 1,200° C. The raw synthesis gas via line 311 can be introduced to the heat exchange system 200 to provide a cooled synthesis gas via line 316. The raw synthesis gas via line 311 can be cooled in the heat exchange system 200 using the heat transfer fluid introduced via line 226. The heated heat transfer fluid via line 228 can be used to power one or more steam turbines (not shown) that can drive a directly coupled electric generator (not shown).

The cooled synthesis gas via line 316 can be introduced to the one or more particulate removal systems 320 to partially or completely remove particulates from the cooled synthesis gas via line 316 to provide a separated or “particulate-lean” synthesis gas via line 321, separated particulates via line 322, and condensate via line 323. Although not shown, steam can be supplied during startup to the particulate removal system 320.

Although not shown, the one or more particulate removal systems 320 can optionally be used to partially or completely remove particulates from the raw synthesis gas via line 311 before cooling. For example, the raw synthesis gas via line 311 can be introduced directly to the particulate removal system 320, resulting in hot gas particulate removal (e.g., from about 550° C. to about 1,050° C.). Although not shown, two particulate removal systems 320 can be used. For example, one particulate removal system 320 can be upstream of the synthesis gas cooler 200 and one particulate removal system 320 can be downstream of the synthesis gas cooler 200.

The one or more particulate removal systems 320 can include one or more separation devices such as conventional disengagers and/or cyclones (not shown). Particulate control devices (“PCD”) capable of providing an outlet particulate concentration below the detectable limit of about 0.1 ppmw can also be used. Illustrative PCDs can include, but are not limited to, sintered metal filters, metal filter candles, and/or ceramic filter candles (for example, iron aluminide filter material). A small amount of high-pressure recycled synthesis gas can be used to pulse-clean the filters as they accumulate particles from the unfiltered synthesis gas.

The separated particulates via line 322 can be introduced to the heat exchange system 340 to produce cooled particulates via line 341 and condensate via line 342. The separated particulates via line 342 and/or the cooled particulates via line 341 can have a particle diameter size of about 20 μm or less, about 15 μm or less, about 12 μm or less, or about 9 μm or less. Although not shown, one or more heat exchange systems 340 can be joined to the same particulate removal system 320 or to multiple particulate removal systems 320. For example, four heat exchange systems 200 can be linked in parallel to each other and to the particulate removal system 320.

Embodiments of the present disclosure further relate to any one or more of the following paragraphs:

1. A heat exchanger, comprising: a housing; a plurality of tubes disposed within the housing; and a plurality of solid particulates disposed within the housing between an inner surface of the housing and outer surfaces of the tubes, wherein the solid particulates have an average cross-sectional length from about 250 μm to about 5 mm.

2. The heat exchanger according to paragraph 1, further comprising a grate disposed in the housing, wherein the grate includes a plurality of openings each having a cross-sectional length less than about 250 μm.

3. The heat exchanger according to paragraph 1 or 2, further comprising first and second tube sheets disposed within the housing, wherein the plurality of tubes comprises a plurality of inner tubes disposed at least partially within a plurality of outer tubes, wherein the outer tubes are coupled to the second tube sheet, and wherein the inner tubes are coupled to the first tube sheet.

4. The heat exchanger according to any one of paragraphs 1 to 3, wherein the solid particulates fill from about 10% to about 80% of an interior volume of the housing.

5. The heat exchanger according to any one of paragraphs 1 to 4, wherein the solid particulates comprise sand, ash, ceramic particles, or combinations thereof.

6. A system for cooling a synthesis gas, comprising: a gasifier for converting a feed to a synthesis gas; a heat exchanger adapted to receive the synthesis gas from the gasifier, the heat exchanger comprising: a housing; a plurality of tubes disposed within the housing and adapted to have a heat transfer fluid flow therethrough; and a first plurality of solid particulates disposed within the housing between an inner surface of the housing and outer surfaces of the tubes; and a reservoir having a second plurality of solid particulates disposed therein, the reservoir comprising: an inlet for receiving at least a portion of the first plurality of solid particulates from the heat exchanger; and an outlet for transferring at least a portion of the second plurality of solid particulates to the heat exchanger.

7. The system according to paragraph 6, wherein the solid particulates have an average cross-sectional length from about 250 μm to about 5 mm.

8. The system according to paragraph 6 or 7, further comprising: a first inlet in the housing for receiving the synthesis gas from the gasifier at a first temperature; a second inlet in the housing for receiving the heat transfer fluid at a first temperature; a third inlet in the housing for receiving the portion of the second plurality of solid particulates from the reservoir; a first outlet in the housing for discharging the synthesis gas at a second temperature; a second outlet in the housing for discharging the heat transfer fluid at a second temperature; and a third outlet in the housing for transferring the portion of the first plurality of particulates from the heat exchanger.

9. The system according to paragraph 8, further comprising: a first line coupled to and extending between the third inlet in the housing and the outlet of the reservoir; a second line coupled to and extending between the third outlet in the housing and the inlet in the reservoir; and a third line coupled to and extending between the housing and the reservoir for maintaining the interior volume of the housing and an interior volume of the reservoir at substantially the same pressure

10. The system according to paragraph 9, further comprising wherein the first and second pluralities of solid particulates are the same type of solid particulates.

11. A method for cooling a synthesis gas, comprising: introducing a synthesis gas at a first temperature to a first inlet of a heat exchanger, wherein the synthesis gas flows through a plurality of solid particulates disposed within an interior volume of the heat exchanger, and wherein the solid particulates absorb heat from the synthesis gas; introducing a heat transfer fluid at a first temperature to a second inlet of the heat exchanger, wherein the heat transfer fluid flows through a plurality of tubes in the heat exchanger, and wherein the heat transfer fluid absorbs heat from the solid particulates through the tubes; discharging the synthesis gas at a second temperature through a first outlet of the heat exchanger; and discharging the heat transfer fluid at a second temperature through a second outlet of the heat exchanger.

12. The method according to paragraph 11, wherein the first temperature of the synthesis gas is from about 800° C. to about 1,200° C., and where the second temperature of the synthesis gas is from about 200° C. to about 450° C.

13. The method according to paragraph 11 or 12, wherein the solid particulates have an average cross-sectional length from about 250 μm to about 5 mm.

14. The method according to any one of paragraphs 11 to 13, wherein first and second tube sheets are disposed within the heat exchanger, wherein the plurality of tubes comprises a plurality of inner tubes disposed at least partially within a plurality of outer tubes, wherein the outer tubes are coupled to the second tube sheet, and wherein the inner tubes are coupled to the first tube sheet.

15. The method according to any one of paragraphs 11 to 14, wherein the solid particulates form a bed in the heat exchanger, and wherein a ratio of a height of the bed of solid particulates to a length of the heat exchanger is from about 0.1:1 to about 0.8:1.

16. The method according to any one of paragraphs 11 to 15, further comprising transferring at least a portion of the solid particulates from the heat exchanger to a reservoir through a line extending therebetween.

17. The method according to paragraph 16, further comprising introducing a gas into the line to facilitate the transfer of the portion of the solid particulates.

18. The method according to paragraph 16, further comprising: introducing a first gas into the line at a first point to cause the portion of the solid particulates to be discharged from the heat exchanger; and introducing a second gas into the line at a second point to cause the portion of the solid particulates to flow into the reservoir.

19. The method according to any one of paragraphs 11 to 18, further comprising transferring additional solid particulates from the reservoir to the heat exchanger through a line extending therebetween.

20. The method according to paragraph 19, further comprising introducing a gas into the line to facilitate the transfer of the additional solid particulates.

Certain embodiments and features have been described using a set of numerical upper limits and a set of numerical lower limits. It should be appreciated that ranges from any lower limit to any upper limit are contemplated unless otherwise indicated. Certain lower limits, upper limits, and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present disclosure, other and further embodiments of the disclosure may be devised without departing from the basic scope thereof, and the scope thereof is determined by the claims that follow.

What is claimed is:

1. A heat exchanger, comprising:
a housing;
a plurality of tubes disposed within the housing; and
a plurality of solid particulates disposed within the housing between an inner surface of the housing and outer surfaces of the tubes, wherein the solid particulates have an average cross-sectional length from about 250 μm to about 5 mm.

2. The heat exchanger of claim 1, further comprising a grate disposed in the housing, wherein the grate includes a plurality of openings each having a cross-sectional length less than about 250 μm.

3. The heat exchanger of claim 1, further comprising first and second tube sheets disposed within the housing, wherein the plurality of tubes comprises a plurality of inner tubes disposed at least partially within a plurality of outer tubes, wherein the outer tubes are coupled to the second tube sheet, and wherein the inner tubes are coupled to the first tube sheet.

4. The heat exchanger of claim 1, wherein the solid particulates fill from about 10% to about 80% of an interior volume of the housing.

5. The heat exchanger of claim 1, wherein the solid particulates comprise sand, ash, ceramic particles, or combinations thereof.

6. A system for cooling a synthesis gas, comprising:
a gasifier for gasifying a feed to a synthesis gas;
a heat exchanger adapted to receive the synthesis gas from the gasifier, the heat exchanger comprising:
a housing;
a plurality of tubes disposed within the housing and adapted to have a heat transfer fluid flow therethrough; and
a first plurality of solid particulates disposed within the housing between an inner surface of the housing and outer surfaces of the tubes; and
a reservoir having a second plurality of solid particulates disposed therein, the reservoir comprising:
an inlet for receiving at least a portion of the first plurality of solid particulates from the heat exchanger; and
an outlet for transferring at least a portion of the second plurality of solid particulates to the heat exchanger.

7. The system of claim 6, wherein the solid particulates have an average cross-sectional length from about 250 μm to about 5 mm.

8. The system of claim 6, further comprising:
a first inlet in the housing for receiving the synthesis gas from the gasifier at a first temperature;
a second inlet in the housing for receiving the heat transfer fluid at a first temperature;
a third inlet in the housing for receiving the portion of the second plurality of solid particulates from the reservoir;
a first outlet in the housing for discharging the synthesis gas at a second temperature;
a second outlet in the housing for discharging the heat transfer fluid at a second temperature; and
a third outlet in the housing for transferring the portion of the first plurality of particulates from the heat exchanger.

9. The system of claim 8, further comprising:
a first line coupled to and extending between the third inlet in the housing and the outlet of the reservoir;
a second line coupled to and extending between the third outlet in the housing and the inlet in the reservoir; and
a third line coupled to and extending between the housing and the reservoir for maintaining the interior volume of the housing and an interior volume of the reservoir at substantially the same pressure.

10. The system of claim 9, wherein the first and second pluralities of solid particulates are the same type of solid particulates.

11. A method for cooling a synthesis gas, comprising:
introducing a synthesis gas at a first temperature to a first inlet of a heat exchanger, wherein the synthesis gas flows through a plurality of solid particulates disposed within an interior volume of the heat exchanger, and wherein the solid particulates absorb heat from the synthesis gas;
introducing a heat transfer fluid at a first temperature to a second inlet of the heat exchanger, wherein the heat transfer fluid flows through a plurality of tubes in the heat exchanger, and wherein the heat transfer fluid absorbs heat from the solid particulates through the tubes;
discharging the synthesis gas at a second temperature through a first outlet of the heat exchanger; and
discharging the heat transfer fluid at a second temperature through a second outlet of the heat exchanger.

12. The method of claim 11, wherein the first temperature of the synthesis gas is from about 800° C. to about 1,200° C., and where the second temperature of the synthesis gas is from about 200° C. to about 450° C.

13. The method of claim 11, wherein the solid particulates have an average cross-sectional length from about 250 μm to about 5 mm.

14. The method of claim 11, wherein first and second tube sheets are disposed within the heat exchanger, wherein the plurality of tubes comprises a plurality of inner tubes disposed at least partially within a plurality of outer tubes, wherein the outer tubes are coupled to the second tube sheet, and wherein the inner tubes are coupled to the first tube sheet.

15. The method of claim 11, wherein the solid particulates form a bed in the heat exchanger, and wherein a ratio of a height of the bed of solid particulates to a length of the heat exchanger is from about 0.1:1 to about 0.8:1.

16. The method of claim 11, further comprising transferring at least a portion of the solid particulates from the heat exchanger to a reservoir through a line extending therebetween.

17. The method of claim 16, further comprising introducing a gas into the line to facilitate the transfer of the portion of the solid particulates.

18. The method of claim 16, further comprising:
introducing a first gas into the line at a first point to cause the portion of the solid particulates to be discharged from the heat exchanger; and
introducing a second gas into the line at a second point to cause the portion of the solid particulates to flow into the reservoir.

19. The method of claim 11, further comprising transferring additional solid particulates from the reservoir to the heat exchanger through a line extending therebetween.

20. The method of claim 19, further comprising introducing a gas into the line to facilitate the transfer of the additional solid particulates.
